(19) United States
(12) Patent Application Publication
(10) Pub. No.: US 2014/0085224 A1
(43) Pub. Date: Mar. 27, 2014

(54) TOUCH DISPLAY METHOD AND ELECTRONIC APPARATUS THEREOF

(71) Applicant: GETAC TECHNOLOGY CORPORATION, Hsinchu County (TW)

(72) Inventor: Chin-Jung CHANG, Taipei City (TW)

(73) Assignee: GETAC TECHNOLOGY CORPORATION, Hsinchu County (TW)

(21) Appl. No.: 13/763,586

(22) Filed: Feb. 8, 2013

(30) Foreign Application Priority Data
Sep. 25, 2012 (CN) 201210358994.5

(51) Int. Cl. G06F 3/041

(52) U.S. Cl. CPC G06F 3/0416
USPC 345/173

(57) ABSTRACT

A touch display method and an electronic apparatus thereof. The electronic apparatus includes a touch display module. The touch display module has a touch display device. The method includes the following steps: loading basic input/output system (BIOS) to execute an initialization program to perform an initialization of the electronic apparatus, when the electronic apparatus has not loaded an operating system; defining a virtual input area in the touch display device and display an input interface in the virtual input area. When the touch display device is touched, a touch event is generated and translated to a coordinate; determining whether the coordinate is in the input interface through the BIOS; when the coordinate is in the input interface, translating the coordinate into a functional code through the BIOS, and executing an operation corresponding to the functional code.

### BACKGROUND

1. Technical Field

The invention relates generally to an electronic apparatus, and more particularly to an electronic apparatus capable of providing an input function during an initialization stage and a touch display method thereof.

2. Related Art

In today's society, the touch screen has become one of the most commonly technologies in the daily lives, and the touch screen can be found in an electronic device such as mobile phone, tablet computer, automatic teller machine (ATM), and the personal digital assistant (PDA). Because the touch screen can provide people with an operating experience distinct from the operating experience of the traditional physical keys, the current trend is towards fewer physical keys on the electronic device. However, even though the touch screen provides people with a high degree of convenience, people may be inconvenienced by insufficient physical keys when operating the electronic device sometimes.

For example, when the user needs to input commands into the electronic device during the initialization and the driver of the touch screen has not been loaded (e.g., selecting a boot mode), the electronic device itself would not have a sufficient amount of physical keys for the user. Accordingly, the user can not input some required commands and feels inconvenienced in the initialization process.

### SUMMARY

The invention provides an electronic apparatus and a touch display method thereof, capable of providing an input function for an user when the electronic apparatus executes an initialization and the driver program of the touch screen has not been loaded by the operating system.

The invention provides an electronic apparatus including a processor and a touch display module. The processor executes an operating system and loads a basic input/output system (BIOS) to execute an initialization program. The touch display module includes a touch display device and a touch input controller. The touch display device has a virtual input area, and a touch event is generated when the touch display device is touched. The touch input controller is coupled to the touch display device and the processor, and the touch input controller receives the touch event and translates the touch event into a coordinate. When the electronic apparatus has loaded the initialization program and the electronic apparatus has not loaded the operating system, the virtual input area displays an input interface, and the processor determines whether the coordinate is in the input interface through the BIOS. When the electronic apparatus has loaded the initialization program and the electronic apparatus has not loaded the operating system, and the coordinate is in the input interface, the processor translates the coordinate into a functional code through the BIOS, and the processor executes an operation corresponding to the functional code.

According to an embodiment of the invention, after the electronic apparatus loads the operating system, the touch display module is defined as a touch screen.

According to an embodiment of the invention, electronic apparatus loads the initialization program to perform an initialization. After the electronic apparatus completes the initialization, the processor executes and loads the operating system.

According to an embodiment of the invention, the input interface displayed by the virtual input area includes a plurality of functional key icons, and each of the functional key icons corresponds to a different functional code.

According to an embodiment of the invention, when the coordinate is in a touched functional key icon of the plurality of functional key icons, the processor translates the touched functional key icon where the coordinate is located into the corresponding functional code through the BIOS.

According to an embodiment of the invention, when the coordinate is not in the virtual input area, the processor outputs the coordinate through the BIOS.

According to an embodiment of the invention, the processor executes a functional key function according to the functional code.

From another perspective, the invention provides a touch display method, adapted for an electronic apparatus having a touch display module, in which the touch display module has a touch display device. The touch display method includes the following steps. A BIOS is loaded to execute an initialization program in order to perform an initialization of the electronic apparatus, the electronic apparatus not having loaded an operating system at this time. A virtual input area is defined in the touch display device, and an input interface is displayed on the virtual input area. A touch event is generated when the touch display device is touched, and the touch event is translated into a coordinate. Thereafter, whether the coordinate is in the input interface is determined through the BIOS. When the coordinate is in the input interface, the coordinate is translated into a functional code through the BIOS, and an operation corresponding to the functional code is executed.

According to an embodiment of the invention, the touch display method further includes loading the electronic apparatus in the operating system, and defining the touch display module as a touch screen.

According to an embodiment of the invention, the input interface displayed by the virtual input area includes a plurality of functional key icons, and each of the functional key icons corresponds to a different functional code.

According to an embodiment of the invention, in the step of translating the coordinate into the functional code through the BIOS, when the coordinate is in a touched functional key icon of the plurality of functional key icons, the BIOS outputs a functional code corresponding to the touched functional key icon where the coordinate is located.

According to an embodiment of the invention, the touch display method further includes when the coordinate is not in the input interface, the BIOS outputting the coordinate.

According to an embodiment of the invention, the step of executing the operation according to the functional code includes executing the functional key function according to the functional code.

In summary, by using the electronic apparatus and the touch display method thereof provided in the embodiments of the invention, the user can still input in the electronic apparatus through the input interface when the electronic apparatus is initializing and has not loaded the operating system. Accordingly, when the user operates the electronic apparatus, the efficiency and flexibility are enhanced.

Several exemplary embodiments accompanied with figures are described in detail below to further describe the disclosure in details.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a functional block diagram of an electronic apparatus according to an embodiment of the invention.

FIG. 2A is a schematic view of an input interface displayed on an electronic apparatus according to an embodiment of the invention.

FIG. 2B is a schematic view of an input interface displayed on an electronic apparatus according to another embodiment of the invention.

FIG. 3 is a schematic view of inputting with an input interface during an initialization stage according to an embodiment of the invention.

FIG. 4 is a flow chart of a touch display method according to an embodiment of the invention.

### DESCRIPTION OF EMBODIMENTS

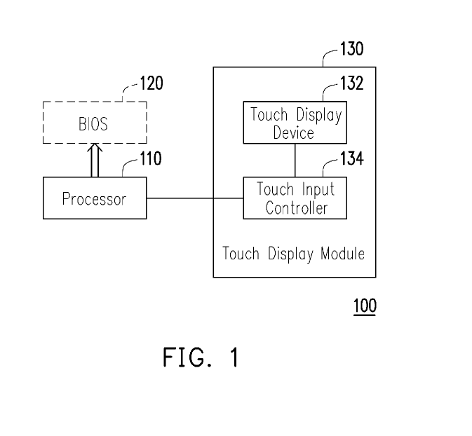

FIG. 1 is a functional block diagram of an electronic apparatus according to an embodiment of the invention. With reference to FIG. 1, in the present embodiment, an electronic apparatus 100 includes a processor 110 and a touch display module 130. The processor 110 executes an operating system and loads a basic input/output system (BIOS) 120 to execute an initialization program. The operating system may be Windows, Linux, or Macintosh. The processor 110 may be a central processing unit (CPU). Moreover, in some embodiments, the processor 110 may include the functions of a north bridge chip and a south bridge chip, or a hardware component such as a micro controller unit (MCU), a processing chip, or a computer system, or a software component capable of signal processing functions (e.g., a signal processing application program). Moreover, the processor 110 may also be a combination of hardware and software components, although the possible implementations in the invention are not limited thereto.

The BIOS 120 may be a program code stored in a memory (not drawn), and the processor 110 may access the program code of the BIOS 120 in the memory in order to execute the initialization program. For example, when the electronic apparatus 100 is being initialized, the processor 110 (e.g. the CPU) may execute the program code of the BIOS 120. In addition, the BIOS 120 may include one of hardware, software, or firmware, or a combination thereof, although the invention is not limited thereto.

The initialization program may initialize components such as chipsets and memory subsystems, although the invention is not limited thereto. On the other hand, the processor 110 may perform diagnostics on hardware components such as keyboard, hard drive, and input/output ports in order to ensure these hardware components can be initialized and operate normally. The touch display module 130 includes a touch display device 132 and a touch input controller 134. The touch input controller 134 is coupled to the processor 110 and the touch display device 132. The touch display device 132 may be a capacitive, resistive, or wave-based implemented touch screen, although the invention is not limited thereto. In other embodiments, the touch input controller 134 may be coupled to the processor 110 through components such as the northbridge chip (not drawn) or the southbridge chip (not drawn).

In order to enhance flexibility and freedom for operating the electronic apparatus 100, a virtual input area of the touch display device 132 can be used to implement a virtual input function such as virtual keyboard function, so that the user can perform more diverse input operations. Therefore, when the functions provided by the physical buttons of the electronic apparatus 100 cannot fulfill the needs of the user, the user can input by the virtual input function (e.g., the virtual keyboard).

In one embodiment, when the processor 110 in the electronic apparatus 100 (e.g. a rugged tablet computer) loads the BIOS 120 and executes the initialization program, the user may need to carry out some settings. Therefore, the processor 110 can perform the corresponding initialization operations according to user's settings when the processor 110 executes the program code of the BIOS 120. However, during the initialization process, since the operating system of the electronic apparatus 100 has not loaded the driver of the touch display module 130, the user cannot input operations into the electronic apparatus 100 through the undriven touch display module 130. At this time, the touch display device 132 in the electronic apparatus 100 can display an input interface (e.g., a virtual keyboard or a virtual keypad) in the virtual input area, so that the user can perform touch input operations, for example, through the input interface. Moreover, a plurality of functional key icons (e.g., the ESC, ENTER, UP↑), DOWN(↓), LEFT(←), RIGHT(→) keys in the keyboard) may be included in the input interface.

When the virtual input area of the touch display device 132 is touched, the touch display device 132 can accordingly generate a touch event. So the touch input controller 134 can receive the touch event and translate the touch event into a corresponding coordinate of the touch display device 132. Thereafter, the touch input controller 134 can transmit the coordinate corresponding to the touch event to the processor 110 executing the program code of the BIOS 120, so that the program code of the BIOS 120 can determine whether the coordinate is located in the display areas of the functional key icons in the input interface through a coordinate judgment function in the program code, for example. When the BIOS 120 determines that the coordinate is located in the display area of a certain functional key icon, the processor 110 can execute an operation related to the functional key icon.

For example, when the user touches the virtual ESC key in the virtual keyboard (e.g. the input interface) displayed on the touch display device 132, the processor 110 translates the touch coordinate into a functional code corresponding to the ESC key through the coordinate translation function in the program code of the BIOS 120. Thereafter, the processor 110 can execute the functional key function (e.g., leaving a certain menu) corresponding to the functional code. It should be noted that the aforementioned coordinate judgment function and coordinate translation function can be implemented by modifying the traditional BIOS program code, although embodiments of the invention are not limited thereto.

In one embodiment, after the electronic apparatus 100 has been initialized, the operating system can be loaded, and the touch display module 132 can be defined as the touch screen through the driver program loaded by the operating system.

On the other hand, when the touched location on the touch display device 132 is not in the input interface area (e.g. the virtual keyboard), the coordinate is directly outputted, due to the BIOS 120 cannot translate the coordinate of the current touch event into the corresponding functional code. The processor 110 can be notified that the output coordinate from the BIOS 120 does not correspond to any functional code through a format judgment function, for example, and accordingly the processor 110 does not execute any functional key function. Alternatively, when the processor 110 receives the coordinate, the processor 110 voluntarily executes the corresponding operating.

Accordingly, during the stage where the electronic apparatus 100 has executed the initialization program and not initialized the operating system, the user can still input operations into the electronic apparatus 100 through the input interface provided by the touch display device 132. Therefore, the user operations are not limited by the functions provided with the originally available physical keyboard of the electronic apparatus 100.

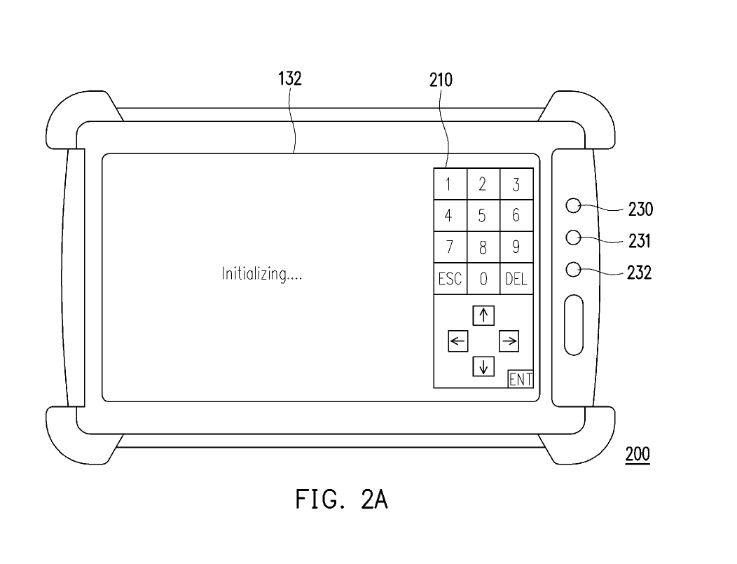

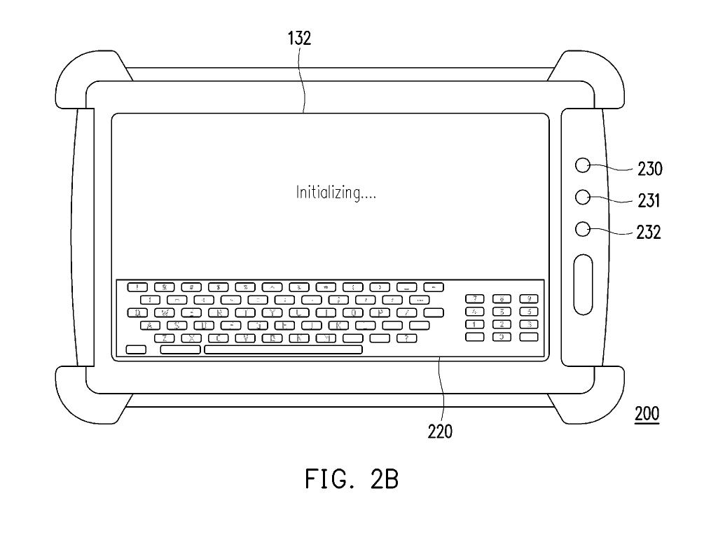

FIG. 2A is a schematic view of an input interface displayed on an electronic apparatus according to an embodiment of the invention. In the present embodiment, the electronic apparatus 200 may include the physical keys 230-232 and the input interface is implemented by a virtual numeric keyboard 210, for instance. The virtual numeric keyboard 210 may be displayed on a right side of the touch display device 132 for user's convenience. Therefore, when the electronic apparatus 200 is being initialized, the user can control objects such as a menu through the ESC, UP(↑), DOWN(↓), LEFT(←), RIGHT(→) keys in the virtual numeric keyboard 210.

FIG. 2B is a schematic view of an input interface displayed on an electronic apparatus according to another embodiment of the invention. In the present embodiment, the input interface may be implemented by a virtual keyboard 220. The virtual keyboard 220 may be displayed at a lower part of the touch display device 132 for user's convenience. Therefore, when the electronic apparatus 200 is being initialized, the user may also input through the virtual keys in the virtual keyboard 220.

As well known by people skilled in the art, the displayed location of the aforementioned input interface (e.g., the virtual numeric keyboard 210 and the virtual keyboard 220) on the touch display device 132 and the placement of the functional key icons may be adjusted according to the requirements of different designs, and embodiments of the invention are not limited thereto.

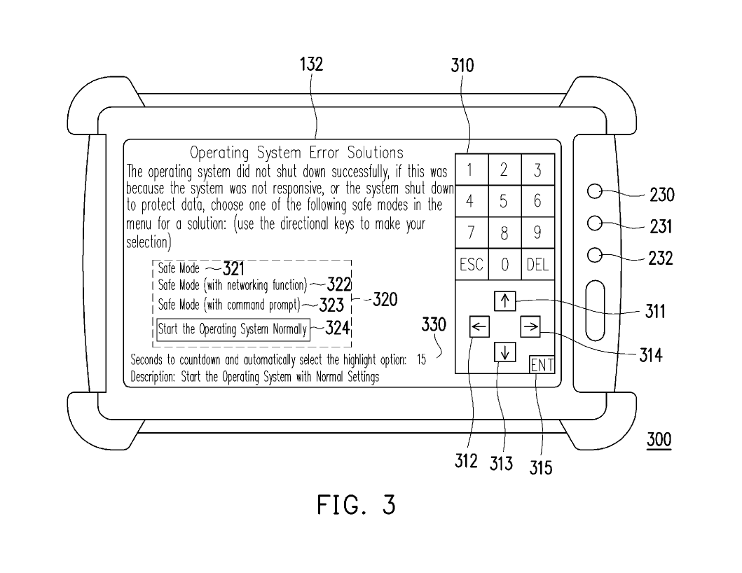

FIG. 3 is a schematic view of inputting with an input interface during an initialization stage according to an embodiment of the invention. In the present embodiment, when an abnormal shutdown occurs during a previous operation of the electronic apparatus 300, a displayed screen in FIG. 3 may be shown the during the initialization stage of the next boot up. Accordingly, the user can voluntarily select whether to load the operating system in a safe mode, for example. In FIG. 3, the displayed screen of the touch display device 132 includes a menu 320 which includes a plurality of options 321-324. When the situation as shown as FIG. 3 occurs, the user can select an option through the directional keys 311-314 in a virtual numeric keyboard 310, and the user can execute the operation corresponding to the selected option by an ENT key 315 (enter key). Therefore, the user can execute the operation corresponding to the selected option before a countdown of a leftover time 330 (e.g. 15 seconds) is completed. So the convenience of the user operation can be enhanced and operating time is saved.

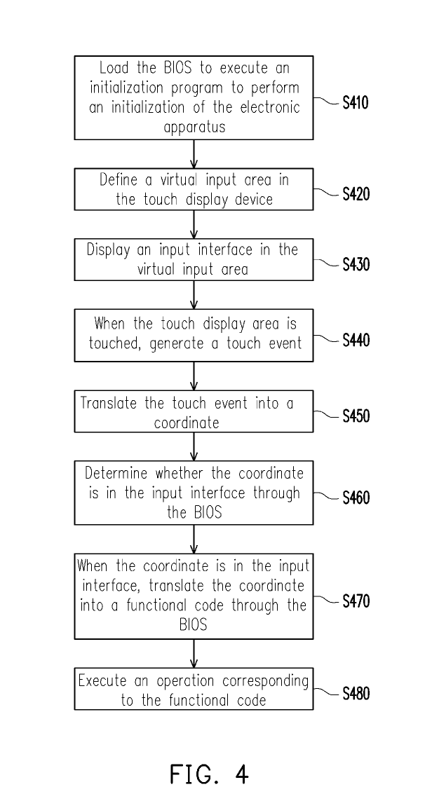

FIG. 4 is a flow diagram of a touch display method according to an embodiment of the invention, in which the touch display method may be executed by the electronic apparatus in FIG. 1. Referring to both FIG. 1 and FIG. 4, the proposed method for switching the applications in the user interface may be adapted for the electronic apparatus 100, but the invention is not limited thereto. In step S410, the processor 110 loads the BIOS 120 to execute an initialization program to perform an initialization of the electronic apparatus 100. At this time, the electronic apparatus 100 has not loaded an operating system. In step S420, a virtual input area is defined in the touch display device 132. Moreover, in step S430, an input interface is displayed in the virtual input area. In step S440, when the touch display area 132 is touched, the touch display device 132 accordingly generates a touch event. In addition, in step S450, the touch input controller 134 translates the touch event into a coordinate. In step S460, the processor 110 determines whether the coordinate is in the input interface through the program code of the BIOS 120. In step S470, when the coordinate is in the input interface, the processor 110 translates the coordinate into a functional code through the BIOS 120. Thereafter, in step S480, the processor 110 executes an operation corresponding to the functional code.

In view of the foregoing, by using the electronic apparatus and the touch display method thereof provided in the embodiments of the invention, the user can still operate on the objects in the menu, for example, through the input interface displayed by the touch display device during the initialization stage of the electronic apparatus. Accordingly, even when the physical buttons on the electronic apparatus have insufficient functions, the user can still input commands into the electronic apparatus through the virtual input interface during the system initialization. Therefore, the operational efficiency and flexibility of the electronic apparatus can be enhanced. Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An electronic apparatus, comprising:
a processor executing an operating system and loading a basic input/output system (BIOS) to execute an initialization program; and
a touch display module, comprising:
a touch display device having a virtual input area, the touch display device generating a touch event when the touch display device is touched; and
a touch input controller coupled to the touch display device and the processor, the touch input controller receiving the touch event and translating the touch event into a coordinate;
wherein, when the electronic apparatus has loaded the initialization program and the electronic apparatus has not loaded the operating system, the virtual input area displays an input interface, and the processor determines whether the coordinate is in the input interface through the BIOS;
wherein, when the electronic apparatus has loaded the initialization program and the electronic apparatus has not loaded the operating system, and the coordinate is in the input interface, the processor translates the coordinate into a functional code through the BIOS, and the processor executes an operation corresponding to the functional code.

2. The electronic apparatus of claim 1, wherein after the electronic apparatus loads the operating system, the touch display module is defined as a touch screen.

3. The electronic apparatus of claim 1, wherein the electronic apparatus loads the initialization program to perform an initialization;
wherein, after the electronic apparatus completes the initialization, the processor executes and loads the operating system.

4. The electronic apparatus of claim 1, wherein the input interface displayed by the virtual input area comprises a plurality of functional key icons, and each of the functional key icons corresponds to a different functional code.

5. The electronic apparatus of claim 4, wherein when the coordinate is in a touched functional key icon of the plurality of functional key icons, the processor translates the coordinate into the functional code which corresponds to the touched functional key icon through the BIOS.

6. The electronic apparatus of claim 1, wherein when the coordinate is not in the virtual input area, the processor outputs the coordinate by the BIOS.

7. The electronic apparatus of claim 1, wherein the processor executes a functional key function according to the functional code.

8. A touch display method, adapted for an electronic apparatus having a touch display module, the touch display module having a touch display device, the touch display method comprising:
loading a BIOS to execute an initialization program to perform an initialization of the electronic apparatus, the electronic apparatus not having loaded an operating system at this time;
defining a virtual input area in the touch display device;
displaying an input interface on the virtual input area;
generating a touch event when the touch display device is touched;
translating the touch event into a coordinate;
determining whether the coordinate is in the input interface through the BIOS;
when the coordinate is in the input interface, translating the coordinate into a functional code through the BIOS; and
executing an operation corresponding to the functional code.

9. The touch display method of claim 8, further comprising:
loading the operating system of the electronic apparatus; and
defining the touch display module as a touch screen.

10. The touch display method of claim 8, wherein the input interface displayed by the virtual input area comprises a plurality of functional key icons, and each of the functional key icons corresponds to a different functional code.

11. The touch display method of claim 10, wherein in the step of translating the coordinate into the functional code through the BIOS, when the coordinate is in a touched functional key icon of the plurality of functional key icons, the BIOS outputs a functional code corresponding to the touched functional key icon where the coordinate is located.

12. The touch display method of claim 8, further comprising:
when the coordinate is not in the input interface, outputting the coordinate through the BIOS.

13. The touch display method of claim 8, wherein the step of executing the operation according to the functional code comprises:
executing a functional key function according to the functional code.
